(19) United States
(12) Patent Application Publication
(10) Pub. No.: US 2010/0132217 A1
(43) Pub. Date: Jun. 3, 2010

(54) DRYER WITH RECIRCULATED AIR PROPORTION AND METHOD FOR OPERATION OF SAME

(75) Inventor: Günter Steffens, Dallgow-Doberitz (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/623,761

(22) Filed: Nov. 23, 2009

(30) Foreign Application Priority Data
Dec. 2, 2008 (DE) 10 2008 044 284.4

(51) Int. Cl. F26B 3/02; F26B 21/06; D06F 58/00; D06F 58/04

(52) U.S. Cl. 34/480; 34/82; 34/131; 34/132

(57) ABSTRACT

A dryer includes a drying chamber, a supply air duct, a process air duct, a heater in the process air duct, a fan, an exhaust air duct, a recirculation duct, and a two-part closure mechanism that includes a fluff separator with a first surface and a second surface, and a damper. The fluff separator and the damper are rotatable against each other such that in a first position of the closure mechanism the damper disconnects the recirculation duct from the process air duct and the fluff separator disconnects the exhaust air duct from the process air duct, and in a second position of the closure mechanism the fluff separator disconnects the recirculation duct from the process air duct.

### BACKGROUND OF THE INVENTION

The invention relates in particular to dryers which are household appliances, in other words appliances for the management of a private household. Such household appliances are in particular known as tumble dryers, washer dryers and dishwashers.

In general a tumble dryer is operated as a vented dryer or condensation dryer. For a drying operation in a vented dryer, air (so-called “process air”) is drawn into the vented dryer from a surrounding area; this air is heated in the vented dryer and directed past the items of washing to be dried for the purpose of taking up moisture and is subsequently discharged from the vented dryer. Since this exhaust air is heavily saturated with moisture, it should not simply be discharged into a building in which the vented dryer is set up. The exhaust air must rather be discharged from the building by means of a suitable ventilation system. In the simplest case this purpose is served by an exhaust hose to be connected to the vented dryer, which is attached to a static ventilation system or is hung out of a window of the building. A condensation dryer, the mode of operation of which is based on the condensation of the moisture evaporated from the washing by means of warm process air carried in a closed process air circuit, does not require an exhaust hose. It also makes it possible in a relatively simple manner to recover energy from the heated process air, for example through the use of a heat pump. The condensate accumulating in the condensation dryer is collected and either pumped away or disposed of by manually emptying a collecting vessel. In the case of a vented dryer the air charged with moisture after passing through a washing drum is generally conveyed out of the dryer. No heat recovery takes place in this situation.

A vented dryer with heat recovery is known. The unexamined patent application DE 30 00 865 A1 thus describes a tumble dryer with heat recovery. The tumble dryer consists of a drum containing and moving the washing, into which flows a supply air stream heated by a heating element, while the moist warm air is conveyed as exhaust air by way of an outlet. A heat exchanger is arranged in the supply air stream upstream of the heating element, through which heat exchanger flows the moist hot exhaust air from the drum.

The energy efficiency of a vented dryer can be improved by a recirculation system in accordance with the aforementioned publication WO 2008/110449 A1. In this situation, the process air charged with moisture from the washing in the drying chamber is partially delivered again by way of the heater to the drying process. The disadvantage in this case is however the fact that a large quantity of fluff originating from the washing in the drying chamber can reach the heater. This can result in a clogging of the downstream air ways including the heater. Moreover, there is an increased danger of burn marks and an increased fire hazard because the fluff may ignite in the heater and reach the washing in the drying chamber. It is likewise disadvantageous that as a result of the higher relative humidity of the exhaust air and the process-dependent low volume of the process air stream carried outside, into the installation room for example, considerably more condensate is produced in the mostly long exhaust air duct and also that more fluff is deposited in the exhaust air duct.

Tumble dryers are known from the documents WO 2008/052906 A1 and WO 2008/077792 A1 and also the already mentioned WO 2008/110449 A1, which in each case have a heat pump.

The publication DE 86 05 014 U1 describes a device for automatically cleaning a fluff filter which is arranged in a filter housing and holds back the fluff contained in an air stream directed through the filter housing and the fluff filter, whereby the fluff filter is mounted in movable fashion. An opening which can be closed by a movable cover is provided in the filter housing. The fluff filter can be introduced into this opening and there are facilities present which generate a cleaning air stream from the rear through the fluff filter. The cleaning of a fluff filter is thus effected by causing air to flow through the fluff filter in the opposite direction, such that adhering fluff is carried outside.

The publication U.S. Pat. No. 1,427,580 A describes a tumble dryer having a heating chamber, a drying chamber communicating with the heating chamber and an exhaust air connection, a fan and a housing therefor. In the FIGS. 1 and 2 in said publication a rotary damper is described, at which a filter is situated. The rotary damper can be adjusted such that two passages are closed such that the air stream in the dryer flows through the filter in opposite directions. The fluff collected in a first position of the filter is conveyed into an exhaust chamber by the air flow in a second position of the filter.

### BRIEF SUMMARY OF THE INVENTION

An object of the present invention is therefore to provide a vented dryer offering high energy efficiency, which uses a proportion of recirculated air and with which the aforementioned disadvantages can be overcome.

The invention relates to a dryer that includes a drying chamber for objects to be dried, a supply air duct, a process air duct in which is situated a heater for heating process air and the heated process air is directed by means of a fan over the objects to be dried and can be directed by way of an exhaust air duct to the exhaust air outlet, whereby a recirculation duct branches off to the heater from the process air duct between the drying chamber and the exhaust air outlet at a branch-off point and the remaining portion of the process air duct leads to the exhaust air outlet as an exhaust air duct, whereby a two-part closure mechanism, comprising a fluff separator with a first surface and a second surface and also a damper, is arranged at the branch-off point, whereby the fluff separator and the damper can be rotated against each other such that in a first position of the closure mechanism the damper disconnects the recirculation duct from the process air duct and the fluff separator disconnects the exhaust air duct from the process air duct, such that process air coming from the drying chamber continues to flow exclusively through the exhaust air duct after passing through the fluff separator, and in a second position of the closure mechanism the fluff separator disconnects the recirculation duct from the process air duct, such that process air coming from the drying chamber can flow both through the recirculation duct after passing through the fluff separator and also through the exhaust air duct.

The recirculation duct preferably rejoins the supply air duct upstream of the heater. This makes accessible a maximum volume of air for the introduction of the heat energy, by which means the occurrence of detrimentally excessive temperatures is excluded to the best possible extent.

By preference, according to an exemplary embodiment of the invention, fluff separator and damper can be positioned dependent on one another or independently of one another. The positioning of the fluff separator and/or the damper can for example be performed by means of a motor or by using a magnet or a thermal actuator.

Moreover, the positioning of the fluff separator and/or the damper can be carried out manually by a user of the dryer or automatically.

For example, a need for cleaning a fluff separator can be ascertained in an already known manner in a dryer and this cleaning requirement notified to a user of the dryer by means of a visual and/or audible indicator device on the dryer. The user can then manually initiate a positioning of fluff separator and/or damper and thus if need be a cleaning of the fluff separator to remove adhering fluff

Alternatively, after a need for cleaning a fluff separator has been ascertained, a positioning of fluff separator and/or damper and thus if need be a cleaning of the fluff separator to remove adhering fluff can be initiated automatically, generally with the aid of a program control facility in the dryer.

Fluff separator and damper preferably form an angle of 90°. In this situation, fluff separator and damper are as a rule permanently connected to each other. For the case where an exhaust air duct branches off at a right angle from a straight running recirculation duct, it is possible in this manner to implement a first position and a second position of the closure mechanism at the branch-off point in a simple manner.

By preference, therefore, fluff separator and damper are capable of rotation around a common axis.

It can however be advantageous if the fluff separator can be removed and separately cleaned. In a preferred embodiment of the invention the fluff separator therefore comprises a frame part seated in the closure device and a removable fluff filter.

The dryer according to an exemplary embodiment of the invention preferably includes at least one heat exchanger. In this manner, opportunities are opened up for the recovery of heat in the dryer according to the invention.

In a preferred embodiment the at least one heat exchanger comprises a heat sink and a heat source of a heat pump. In this situation, basically any heat pump can be used. With regard to a dryer equipped with a heat pump the cooling of the warm process air charged with moisture essentially takes place in the heat sink of the heat pump. The heat thus transferred into the heat pump reaches the heat source of the heat pump, at an elevated temperature as a rule, where heat is released, which is used in particular in order to heat up the process air or supply air prior to entry into the drying chamber.

According to an exemplary embodiment of the invention, the heat released in the heat source can be used in the supply air duct in order to heat supply air or, following combination of supply air duct and recirculation duct, in order to heat the combined supply air and exhaust air.

The recirculation duct is preferably configured such that it permits a branch-off of a proportion of 30 vol % to 75 vol %, by particular preference about 60 vol %, of a process air stream in the process air duct after exiting from the drying chamber.

The invention furthermore relates to a method for operating a dryer that includes a drying chamber for objects to be dried, a supply air duct, a process air duct in which is situated a heater for heating process air and the heated process air is directed by means of a fan over the objects to be dried and can be directed by way of an exhaust air duct to the exhaust air outlet, whereby a recirculation duct branches off to the heater from the process air duct between the drying chamber and the exhaust air outlet at a branch-off point and the remaining portion of the process air duct leads to the exhaust air outlet as an exhaust air duct, whereby a two-part closure mechanism, comprising a fluff separator with a first surface and a second surface, and also a damper, is arranged at the branch-off point, whereby the fluff separator and the damper can be rotated against each other such that in a first position of the closure mechanism the damper disconnects the recirculation duct from the process air duct and the fluff separator disconnects the exhaust air duct from the process air duct, such that process air coming from the drying chamber continues to flow exclusively through the exhaust air duct after passing through the fluff separator, and in a second position of the closure mechanism the fluff separator disconnects the recirculation duct from the process air duct, such that process air coming from the drying chamber can flow both through the recirculation duct after passing through the fluff separator and also through the exhaust air duct, in which method the closure mechanism is moved from the second position into the first position in order to clean the fluff separator of fluff by using the process air to flush fluff located on the second surface into the exhaust air duct.

In the first position of the closure mechanism the air stream in the exhaust air duct is considerably increased, with the result that fluff can be better conveyed to the outside. Thus, in the exhaust air duct, the formation of condensate can be reduced and the removal of fluff improved.

In a preferred embodiment of this method a proportion of 30 vol % to 75 vol % of a process air stream in the process air duct is routed into the recirculation duct after exiting from the drying chamber.

As a result of using a recirculation duct or conveying the hot recirculated air charged with moisture through the recirculation duct to the heater, the air temperature downstream of the heater is generally raised whilst maintaining the same heat output. The drum entry temperature can however remain in the permissible range on account of the increased air stream passing by way of the heater. In order to set a desired drum entry temperature or drum exit temperature, the air stream of the exhaust air, the recirculated air and/or the supply air can be regulated, for example by using a first controllable closure device in the recirculation duct and/or a second controllable closure device in the supply air duct.

In particular, in order to accelerate the heating of the process air after turning the dryer on, the quantity of supply air through the second controllable closure device in the supply air duct can be controlled such that the delivery of supply air is stopped and operation takes place using only recirculated air as process air.

According to an exemplary embodiment of the invention, it is preferable if exhaust air and supply air are in each case carried through the corresponding heat exchangers in a crossflow or counterflow process.

Since the energy required for drying decreases as the degree of dryness of the objects to be dried in the dryer increases, it is advantageous to regulate the heater accordingly, in other words to reduce its heat output as the degree of dryness increases.

### BRIEF DESCRIPTION OF THE DRAWINGS

Further details of the invention will emerge from the description which follows of non-restrictive exemplary embodiments of the dryer according to the invention and a method using this dryer. Reference is made thereby to the FIGS. 1 and 2 from the attached drawing.

FIG. 1 shows a vertical section through a dryer in accordance with one embodiment, in which a closure device is situated at the branch-off point of a recirculation duct from the process air duct and heat recovery takes place by means of an air to air heat exchanger.

FIG. 2 shows an enlarged detail view from a dryer, in which the closure device is illustrated in greater detail.

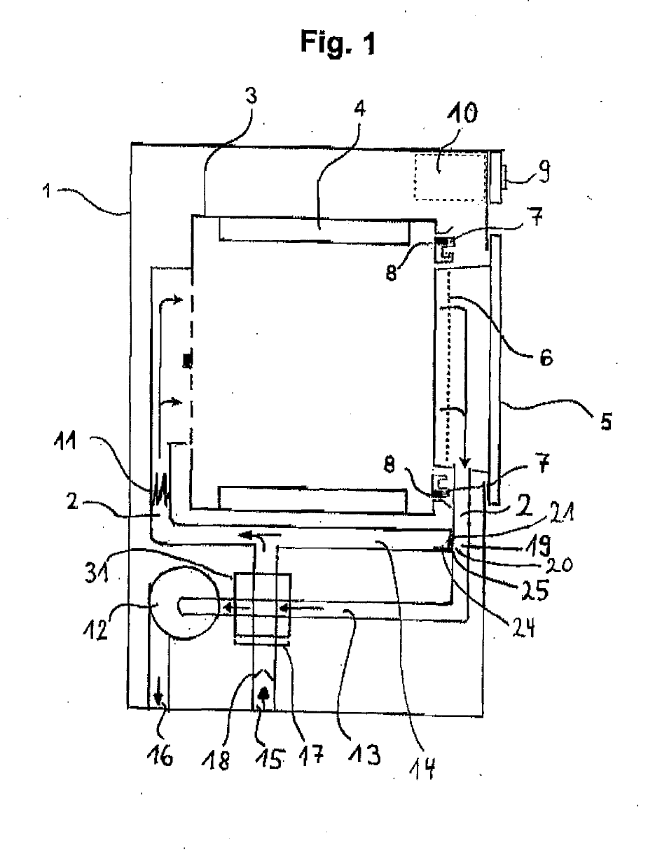

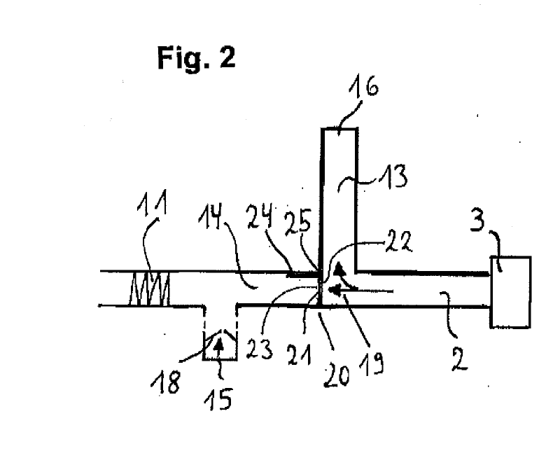

In FIGS. 1 and 2 the long arrows indicate the flow direction of the process air and the short arrows indicate the flow direction of a cooling agent.

### DETAILED DESCRIPTION OF EXEMPLARY EMBODIMENTS OF THE PRESENT INVENTION

The dryer 1 represented in FIG. 1 in accordance with a first embodiment has a drum capable of rotation around a horizontal axis as its drying chamber 3, inside which drum are secured paddles 4 for moving the washing during a drum rotation. Process air is conveyed by means of a fan 12 by way of an electric heater 11, through a drum 3, in a process air duct 2. Ambient air is delivered to the process air duct 2 by way of a supply air duct 15 or drawn in by the fan 12. After passing through the drum 3 the moist warm process air is split up at a branch-off point 19 into a recirculation stream in a recirculation duct 14 and an exhaust stream in an exhaust air duct 13. In the exhaust air duct 13 is situated an air to air heat exchanger 23 in which the process air (here: exhaust air) is cooled and, following condensation of the moisture contained therein, is conveyed to the exhaust air outlet 16.

At the branch-off point 19 is situated a closure mechanism 20 comprising a first fluff filter 21 and also a damper 24. With regard to the embodiment shown in FIG. 1, fluff filter 21 and damper 24 form an angle of 90° and are capable of rotation around a common axis 25.

In the dryer 1, air heated by the heater 11 is conveyed from the rear, in other words from the side of the drum 3 situated opposite a door 5, into the drum 3 through the latter's perforated base, comes into contact there with the washing to be dried and flows through the filling opening of the drum 3 to a second fluff filter 6 inside a door 5 closing the filling opening. The process air stream in the door 5 is then deflected downwards. The process air is essentially delivered in an exhaust air duct 13 to the air to air heat exchanger 23 in which the warm process air charged with moisture is cooled and then taken to an exhaust air outlet 16. The precipitated moisture is collected in a condensate pan 17, whence it can be removed by pumping away for example.

To provide the cooling, ambient air fed to the dryer 1 by way of the supply air duct 15 is used in the air to air heat exchanger 23. This supply air is heated by the warm process air charged with moisture and subsequently further heated by means of the electric heater 11 prior to entering the drying chamber 3. A proportion of the warm process air charged with moisture exiting the drying chamber 3 is branched off into a recirculation duct 14 and conveyed again into the drying chamber 3 by way of the electric heater 11.

With regard to the embodiment shown FIG. 1, the branched-off process air from the recirculation duct 14 and also the supply air preheated in the air to air heat exchanger 23 are combined upstream of the electric heater 11. The supply air stream can be regulated by means of a controllable closure device 18 (dampers 18 for example).

FIG. 3 shows an enlarged detail view from a dryer 1, in which the closure device is illustrated in greater detail. At the branch-off point 19 is situated a closure mechanism 20 comprising a first fluff filter 21 with a first surface 22 and a second surface 23 and also a damper 24. With regard to the embodiment shown FIG. 1, fluff filter 21 and damper 24 form an angle of 90° and are capable of rotation around a common axis 25.

In the second position of the closure mechanism 20 shown in FIG. 3 the fluff separator 21 disconnects the recirculation duct 14 from the process air duct 2, with the result that process air coming from the drying chamber 3 can flow both through the recirculation duct 14 after passing through the fluff separator 21 and also through the exhaust air duct 13.

1. A dryer comprising:
a drying chamber;
a supply air duct;
a process air duct;
a heater in the process air duct for heating process air;
a fan for directing the heated process air over the objects to be dried;
an exhaust air duct for directing the heated process air to an exhaust air outlet;
a recirculation duct that branches to the heater from the process air duct between the drying chamber and the exhaust air outlet at a branch-off point, wherein a remaining portion of the process air duct leads to the exhaust air outlet as the exhaust air duct;
a two-part closure mechanism at the branch-off point comprising:
a fluff separator with a first surface and a second surface; and
a damper,
wherein the fluff separator and the damper are rotatable against each other such that in a first position of the closure mechanism the damper disconnects the recirculation duct from the process air duct and the fluff separator disconnects the exhaust air duct from the process air duct, such that process air coming from the drying chamber continues to flow exclusively through the exhaust air duct after passing through the fluff separator, and in a second position of the closure mechanism the fluff separator disconnects the recirculation duct from the process air duct, such that process air coming from the drying chamber can flow both through the recirculation duct after passing through the fluff separator and also through the exhaust air duct.

2. The dryer of claim 1, wherein the recirculation duct joins together with the supply air duct upstream of the heater.

3. The dryer of claim 1, wherein the fluff separator and the damper can be positioned dependent on one another or independently of one another.

4. The dryer of claim 3, wherein the fluff separator and the damper form an angle of 90°.

5. The dryer of claim 3, wherein the fluff separator and the damper are capable of rotation around a common axis.

6. The dryer of claim 1, wherein the fluff separator comprises a frame part seated in the closure device and a removable fluff filter.

7. The dryer of claim 1, wherein the dryer comprises a heat exchanger.

8. The dryer of claim 7, wherein the heat exchanger is an air to air heat exchanger.

9. The dryer of claim 1, further comprising a first controllable closure device in the recirculation duct.

10. The dryer of claim 9, further comprising a second controllable closure device in the supply air duct.

11. A method for operating a dryer that includes a drying chamber, a supply air duct, a process air duct, a heater in the process air duct, a fan, an exhaust air duct, an exhaust air outlet, a recirculation duct branching off to the heater from the process air duct between the drying chamber and the exhaust air outlet at a branch-off point and a remaining portion of the process air duct leads to the exhaust air outlet as an exhaust air duct, a two-part closure mechanism at the branch-off point that includes a fluff separator with a first surface and a second surface and a damper, the fluff separator and the damper being rotatable against each other such that in a first position of the closure mechanism the damper disconnects the recirculation duct from the process air duct and the fluff separator disconnects the exhaust air duct from the process air duct, such that process air coming from the drying chamber continues to flow exclusively through the exhaust air duct after passing through the fluff separator, and in a second position of the closure mechanism the fluff separator disconnects the recirculation duct from the process air duct, such that process air coming from the drying chamber can flow both through the recirculation duct after passing through the fluff separator and also through the exhaust air duct, the method comprising:
moving the closure mechanism from the second position into the first position in order to clean the fluff separator of fluff by using the process air to flush fluff located on the second surface into the exhaust air duct.
